(19) United States
(12) Patent Application Publication
(10) Pub. No.: US 2019/0152218 A1
(43) Pub. Date: May 23, 2019

(54) Correcting Distortions in Digital Printing

(71) Applicant: Landa Corporation Ltd., Rehovot (IL)

(72) Inventors: Yoav Stein, Kiryat Ono (IL); Alon Siman Tov, Or Yehuda (IL)

(21) Appl. No.: 16/258,758

(22) Filed: Jan. 28, 2019

Related U.S. Application Data
(63) Continuation-in-part of application No. 16/047,033, filed on Jul. 27, 2018.
Application No. 16/047,033 is a continuation of application No. 15/818,010, filed on Nov. 20, 2017, now Pat. No. 10,065,411.
Application No. 15/818,010 is a continuation of application No. 15/289,210, filed on Oct. 10, 2016, now Pat. No. 9,884,479.
Application No. 15/289,210 is a continuation of application No. 14/860,776, filed on Sep. 22, 2015, now Pat. No. 9,498,946.
Application No. 14/860,776 is a continuation-in-part of application No. 14/382,880, filed on Sep. 4, 2014, now Pat. No. 9,186,884.
Application No. 14/382,880 is a continuation-in-part of application No. PCT/IB2013/050245, filed on Jan. 10, 2013.
Application No. PCT/IB2013/050245 is a continuation-in-part of application No. PCT/IB2012/056100, filed on Nov. 1, 2012.
Application No. 14/860,776 is a continuation-in-part of application No. 14/340,122, filed on Jul. 24, 2014, now Pat. No. 9,229,664.
Application No. 14/340,122 is a continuation-in-part of application No. PCT/IB2013/050245, filed on Jan. 10, 2013.
(60) Provisional application No. 62/701,164, filed on Jul. 20, 2018.
(60) Provisional application No. 61/606,913, filed on Mar. 5, 2012.
(60) Provisional application No. 61/611,547, filed on Mar. 15, 2012.
(60) Provisional application No. 61/624,896, filed on Apr. 16, 2012.
(60) Provisional application No. 61/641,288, filed on May 1, 2012.
(60) Provisional application No. 61/642,445, filed on May 3, 2012.
(60) Provisional application No. 61/606,913, filed on Mar. 5, 2012.
(60) Provisional application No. 61/611,556, filed on Mar. 15, 2012.
(60) Provisional application No. 61/611,568, filed on Mar. 15, 2012.
(60) Provisional application No. 61/640,720, filed on Apr. 30, 2012.
(60) Provisional application No. 61/641,870, filed on May 2, 2012.
(60) Provisional application No. 61/641,881, filed on May 2, 2012.
(60) Provisional application No. 61/719,894, filed on Oct. 29, 2012.

(51) Int. Cl. B41J 2/005

(52) U.S. Cl. CPC B41J 2/0057

(57) ABSTRACT

A method for correcting distortion in image printing, the method includes receiving a digital image acquired from a printed image including at least first and second colors. Based on the digital image, a first color image of the first color and a second color image of the second color are produced. A first distortion in the first color image and a second distortion in the second color image are estimated. One or more first pixel-shifts that, when applied to respective first pixels in the first color image, compensate for the estimated first distortion, are calculated for the first color image. One or more second pixel-shifts that, when applied to respective second pixels in the second color image, compensate for the estimated second distortion, are calculated for the second color image. A first corrected image is produced by applying the first pixel-shifts to the respective first pixels, and a second corrected image is produced by applying the second pixel-shifts to the respective second pixels. The first corrected image and the second corrected image are printed on a target substrate.

### CROSS-REFERENCE TO RELATED APPLICATIONS

This application claims the benefit of U.S. Provisional Patent Application 62/701,164, filed Jul. 20, 2018.

This application is also a Continuation In Part of U.S. patent application U.S. Ser. No. 16/047,033, filed Jul. 27, 2018, which is a Continuation of U.S. patent application Ser. No. 15/818,010, filed Nov. 20, 2017, which is a Continuation of U.S. patent application Ser. No. 15/289,210, filed Oct. 10, 2016 (now U.S. Pat. No. 9,884,479), which is a continuation of U.S. patent application Ser. No. 14/860,776, filed Sep. 22, 2015 (now U.S. Pat. No. 9,498,946), which is a Continuation In Part of U.S. patent application Ser. No. 14/382,880, filed Sep. 4, 2014 (now U.S. Pat. No. 9,186,884), which is US National Phase of PCT/IB2013/51727, filed Mar. 5, 2013, which claims the benefit of U.S. Provisional Patent Application 61/606,913, filed Mar. 5, 2012, U.S. Provisional Patent Application 61/611,547, filed Mar. 15, 2012, U.S. Provisional Patent Application 61/624,896, filed Apr. 16, 2012, U.S. Provisional Patent Application 61/641,288, filed May 1, 2012, and U.S. Provisional Patent Application 61/642,445, filed May 3, 2012.

PCT/IB2013/51727 is a Continuation In Part of PCT/IB2013/050245, filed Jan. 10, 2013, which is a Continuation In Part of PCT/IB2012/056100, filed Nov. 1, 2012.

U.S. patent application Ser. No. 14/860,776, filed Sep. 22, 2015 (now U.S. Pat. No. 9,498,946) is a Continuation In Part of U.S. patent application Ser. No. 14/340,122, filed Jul. 24, 2014 (now U.S. Pat. No. 9,229,664), which is a Continuation In Part of PCT/IB2013/050245, filed Jan. 10, 2013, which claims the benefit of U.S. Provisional Patent Application 61/606,913, filed Mar. 5, 2012, U.S. Provisional Patent Application 61/611,556, filed Mar. 15, 2012, U.S. Provisional Patent Application 61/611,568, filed Mar. 15, 2012, U.S. Provisional Patent Application 61/640,720, filed Apr. 30, 2012, U.S. Provisional Patent Application 61/641,870, filed May 2, 2012, U.S. Provisional Patent Application 61/641,881, filed May 2, 2012, and U.S. Provisional Patent Application 61/719,894, filed Oct. 29, 2012.

The disclosures of all these related applications are incorporated herein by reference.

### FIELD OF THE INVENTION

The present invention relates generally to digital printing, and particularly to methods and systems for compensating for distortions in digitally printed images.

### BACKGROUND OF THE INVENTION

Various methods and systems for correcting distortions in digitally printed images are known in the art.

For example, U.S. Patent Application Publication 2005/0183603 describes a method and system for a printing device. The method and system comprise printing a test pattern on a print medium and generating a digital image of the printed test pattern by an imaging device. The method and system include analyzing an interference pattern to measure for distortion of the print medium and calibrating the printing device based upon the measured distortion.

### SUMMARY OF THE INVENTION

An embodiment of the present invention that is described herein provides a method for correcting distortion in image printing, the method includes receiving a digital image that includes at least first and second colors. Based on the digital image, a first color image of the first color and a second color image of the second color are produced. A first distortion in the first color image and a second distortion in the second color image are estimated. One or more first pixel-shifts that, when applied to respective first pixels in the first color image, compensate for the estimated first distortion, are calculated for the first color image. One or more second pixel-shifts that, when applied to respective second pixels in the second color image, compensate for the estimated second distortion, are calculated for the second color image. A first corrected image is produced by applying the first pixel-shifts to the respective first pixels, and a second corrected image is produced by applying the second pixel-shifts to the respective second pixels. The first corrected image and the second corrected image are printed on a target substrate.

In some embodiments, printing the first corrected image includes changing a first jetting time of a first printing fluid for correcting the first distortion, and printing the second corrected image includes changing a second jetting time of a second printing fluid for correcting the second distortion. In other embodiments, at least some of the first pixels include a bar of pixels along a section of a column or a row of the first color image, and producing the first corrected image includes applying at least one of the first pixel-shifts to the bar of pixels. In yet other embodiments, the first color image includes one or more first registration targets laid out at respective one or more first designed positions, and the second color image includes one or more second registration targets laid out at respective one or more second designed positions.

In an embodiment, estimating the first distortion Includes measuring a first displacement of at least one of the first registration targets from the first designed position to a first measured position, and estimating the second distortion Includes measuring a second displacement of at least one of the second registration targets from the second designed position to a second measured position. In another embodiment, estimating the first distortion includes calculating the first pixel-shifts based on the first displacement, and estimating the second distortion includes calculating the second pixel-shifts based on the second displacement. In yet another embodiment, producing the first corrected image includes shifting the one or more first pixels so as to compensate for the first displacement, and producing the second corrected image includes shifting the one or more second pixels so as to compensate for the second displacement.

In some embodiments, estimating the first distortion includes producing a first distortion curve by interpolating between the first registration targets, and estimating the second distortion includes producing a second distortion curve by interpolating between the second registration targets. In other embodiments, the method includes calculating a moving average over a predefined number of adjacent data points of at least one of the first and second distortion curves. In yet other embodiments, estimating the first and second distortions includes measuring a first distance between at least one of the first registration targets and a first edge of the target substrate, and measuring a second distance between at least one of the second registration targets and a second edge of the target substrate.

In an embodiment, the method includes receiving multiple digital images acquired from multiple respective printed images and calculating multiple respective first and second color images, estimating multiple first and second distortions in each of the multiple first and second color images, and calculating first and second pixel-shifts based on a statistical analysis of the first and second distortions. In another embodiment, the method includes aligning at least one of the first corrected image and the second corrected image to the substrate based on one or more predefined parameters. In yet another embodiment, the digital image is acquired from a printed image.

There is additionally provided, in accordance with an embodiment of the present invention, a printing system that includes an intermediate transfer member (ITM) and a processor. The ITM is configured to receive droplets of at least first and second printing fluids from an image forming station so as to form thereon an ink image that includes at least a first color of the first printing fluid and a second color of the second printing fluid, and to form a printed image by transferring the ink image to a target substrate. The processor is configured to (a) receive a digital image, (b) produce, based on the digital image, a first color image of the first color and a second color image of the second color, (c) estimate a first distortion in the first color image and a second distortion in the second color image, (d) calculate, for the first color image, one or more first pixel-shifts that, when applied to respective first pixels in the first color image, compensate for the estimated first distortion, (e) calculate, for the second color image, one or more second pixel-shifts that, when applied to respective second pixels in the second color image, compensate for the estimated second distortion, (f) produce a first corrected image by applying the first pixel-shifts to the respective first pixels, and produce a second corrected image by applying the second pixel-shifts to the respective second pixels, and (g) apply the first and second corrected images to the ITM by sending instructions including the first and second corrected images to the image forming station.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIGS. 2 and 3 are schematic, pictorial illustrations of methods for calculating correction of wave X(Y) distortion in images printed using a digital printing system, in accordance with embodiments of the present invention;

FIG. 4 is a schematic, pictorial illustration of a method for implementing the calculated correction of wave X(Y) distortion in a digital printing system, in accordance with an embodiment of the present invention; and

FIG. 5 is a flow chart that schematically illustrates methods for correcting wave X(Y) distortions in an image printed using a digital printing system, in accordance with embodiments of the present invention.

### DETAILED DESCRIPTION OF EMBODIMENTS

### Overview

Embodiments of the present invention that are described hereinbelow provide methods and apparatus for correcting distortions in printing of a digital image. In some embodiments, a digital printing system comprises a flexible intermediate transfer member (ITM) configured to receive an ink image and to move along an axis, referred to herein as an X axis, to an impression station so as to transfer the ink image to a target substrate, such as a paper sheet or a continuous web.

The printed image may have distortions along the X axis that change with the position on a Y axis (orthogonal to the X axis), referred to herein as wave X(Y), and/or distortions along the Y axis that change with the position on the X axis, referred to herein as wave Y(X).

The wave X(Y) distortion may be caused by multiple sources, such as bending and stretching of the flexible ITM, deviation from the specified velocity at the impression station, and misalignment between color images. The digital image may have additional distortions, such as displacement of the digital image relative to the substrate, for example in X axis, also referred to herein as “image to substrate X” (Im2SubX).

In some embodiments, the digital printing system prints an image, which is a composition of multiple color images. The printed image comprises registration targets having multiple colors, such as but not limited to cyan, magenta, yellow and black, each color of registration targets corresponds to a respective color image.

In some embodiments, the digital printing system comprises a processor configured to receive a digital image acquired from the printed image and to decompose the digital image into multiple color images of the aforementioned colors. The processor is configured to estimate, based on the registration targets, wave X(Y) and Im2SubX distortions in each color image.

The processor is further configured to apply, to each of the distorted color images, shifting of pixels so as to compensate for the wave X(Y) distortion, and a linear offset so as to compensate for the Im2SubX distortion. The processor is further configured to produce, for each color, a corrected digital color image, such that the corrected digital color image corrects the wave X(Y) and Im2SubX distortions described above. In some embodiments, the processor is further configured to send an instruction to each nozzle of the digital printing system. The instruction may command the respective nozzle whether or not to jet one or more droplets of ink at a predefined location on the surface of the substrate.

In some embodiments, each of the corrected digital color images is printed and an additional digital image is acquired, from the printed corrected digital color images, so as to check whether the wave X(Y) and Im2SubX distortions have indeed been corrected.

The disclosed techniques improve the quality of printed digital images by compensating for wave X(Y) and other types of distortions, and reduce waste of substrate and ink by improving the yield of the printed substrates.

### System Description

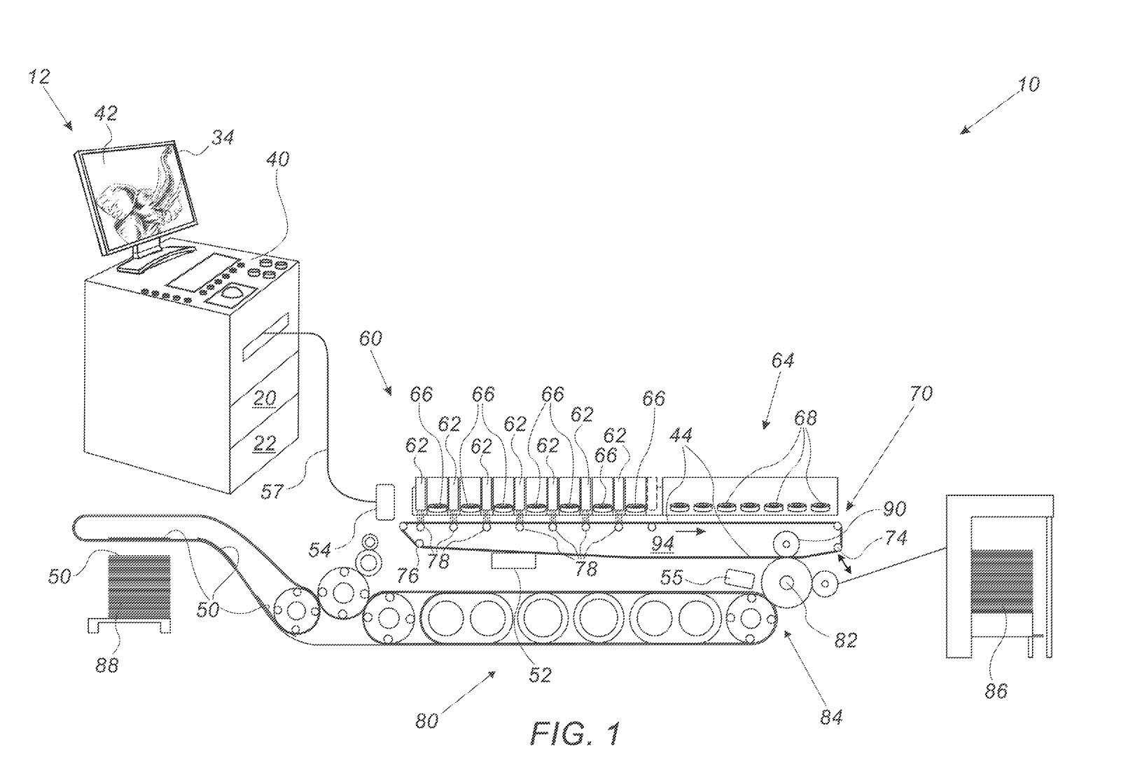

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate member configured to receive an ink image and to transfer the ink image to a target substrate, as will be described in detail below.

In an operative mode, image forming station 60 is configured to form a mirror ink image, also referred to herein as “an ink image” (not shown), of a digital image 42 on an upper run of a surface of blanket 44. Subsequently the ink image is transferred to a target substrate, (e.g., a paper, a folding carton, or any suitable flexible package in a form of sheets or continuous web) located under a lower run of blanket 44.

In the context of the present invention, the term “run” refers to a length or segment of blanket 44 between any two given rollers over which blanket 44 is guided.

In some embodiments, during installation blanket 44 may be adhered edge to edge to form a continuous blanket loop (not shown). An example of a method and a system for the installation of the seam is described in detail in U.S. Provisional Application 62/532,400, whose disclosure is incorporated herein by reference.

In some embodiments, image forming station 60 typically comprises multiple print bars 62, each mounted (e.g., using a slider) on a frame (not shown) positioned at a fixed height above the surface of the upper run of blanket 44. In some embodiments, each print bar 62 comprises a strip of print heads as wide as the printing area on blanket 44 and comprises individually controllable print nozzles.

In some embodiments, image forming station 60 may comprise any suitable number of bars 62, each bar 62 may contain a printing fluid, such as an aqueous ink of a different color. The ink typically has visible colors, such as but not limited to cyan, magenta, red, green, blue, yellow, black and white. In the example of FIG. 1, image forming station 60 comprises seven print bars 62, but may comprise, for example, four print bars 62 having any selected colors such as cyan, magenta, yellow and black.

In some embodiments, the print heads are configured to jet ink droplets of the different colors onto the surface of blanket 44 so as to form the ink image (not shown) on the surface of blanket 44.

In some embodiments, different print bars 62 are spaced from one another along the movement axis of blanket 44, represented by an arrow 94. In this configuration, accurate spacing between bars 62, and synchronization between directing the droplets of the ink of each bar 62 and moving blanket 44 are essential for enabling correct placement of the image pattern.

In the context of the present disclosure and in the claims, the terms “inter-color pattern placement,” “pattern placement accuracy,” color-to-color registration,” “C2C registration” “bar to bar registration,” and “color registration” are used interchangeably and refer to any placement accuracy of two or more colors relative to one another.

In some embodiments, system 10 comprises heaters, such as hot gas or air blowers 66, which are positioned in between print bars 62, and are configured to partially dry the ink droplets deposited on the surface of blanket 44. This hot air flow between the print bars may assist, for example, in reducing condensation at the surface of the print heads and/or in handling satellites (e.g., residues or small droplets distributed around the main ink droplet), and/or in preventing blockage of the inkjet nozzles of the print heads, and/or in preventing the droplets of different color inks on blanket 44 from undesirably merging into one another. In some embodiments, system 10 comprises a drying station 64, configured to blow hot air (or another gas) onto the surface of blanket 44. In some embodiments, drying station comprises air blowers 68 or any other suitable drying apparatus.

In drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered tacky ink film.

In some embodiments, system 10 comprises a blanket module 70 comprising a rolling ITM, such as a blanket 44. In some embodiments, blanket module 70 comprises one or more rollers 78, wherein at least one of rollers 78 comprises an encoder (not shown), which is configured to record the position of blanket 44, so as to control the position of a section of blanket 44 relative to a respective print bar 62. In some embodiments, the encoder of roller 78 typically comprises a rotary encoder configured to produce rotary-based position signals indicative of an angular displacement of the respective roller.

Additionally or alternatively, blanket 44 may comprise an integrated encoder (not shown) for controlling the operation of various modules of system 10. The integrated encoder is described in detail, for example, in U.S. Provisional Application 62/689,852, whose disclosure is incorporated herein by reference.

In some embodiments, blanket 44 is guided over rollers 76 and 78 and a powered tensioning roller, also referred to herein as a dancer 74. Dancer 74 is configured to control the length of slack in blanket 44 and its movement is schematically represented by a double sided arrow. Furthermore, any stretching of blanket 44 with aging would not affect the ink image placement performance of system 10 and would merely require the taking up of more slack by tensioning dancer 74.

In some embodiments, dancer 74 may be motorized. The configuration and operation of rollers 76 and 78, and dancer 74 are described in further detail, for example, in U.S. Patent Application Publication 2017/0008272 and in the above-mentioned PCT International Publication WO 2013/132424, whose disclosures are all incorporated herein by reference.

In impression station 84, blanket 44 passes between an impression cylinder 82 and a pressure cylinder 90, which is configured to carry a compressible blanket.

In some embodiments, system 10 comprises a control console 12, which is configured to control multiple modules of system 10, such as blanket module 70, image forming station 60 located above blanket module 70, and a substrate transport module 80 located below blanket module 70.

In some embodiments, console 12 comprises a processor 20, typically a general-purpose computer, with suitable front end and interface circuits for interfacing with a controller 54, via a cable 57, and for receiving signals therefrom. In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and various types of test patterns (described in detail below) stored in memory 22.

In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52 the temperature of blanket 44 can be reduced to a desired value before blanket 44 enters image forming station 60. The treatment may be carried out by passing blanket 44 over one or more rollers or blades configured for applying cooling and/or cleaning and/or treatment fluid on the outer surface of the blanket. In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International Publications WO 2013/132424 and WO 2017/208152, whose disclosures are all incorporated herein by reference.

Additionally or alternatively, treatment fluid may be applied by jetting, prior to the ink jetting at the image forming station.

In the example of FIG. 1, station 52 is mounted between roller 78 and roller 76, yet, station 52 may be mounted adjacent to blanket 44 at any other suitable location between impression station 84 and image forming station 60.

In the example of FIG. 1, impression cylinder 82 impresses the ink image onto the target flexible substrate, such as an individual sheet 50, conveyed by substrate transport module 80 from an input stack 86 to an output stack 88 via impression cylinder 82. In other embodiment, the target flexible substrate may comprise a continuous web (not shown) or any other suitable substrate.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two impression cylinders so as to permit duplex printing. This configuration also enables conducting single sided prints at twice the speed of printing double sided prints. In addition, mixed lots of single and double sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

As briefly described above, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by compressible blanket (not shown), of pressure cylinder 90 against sheet 50 (or other suitable substrate) so that the ink image is impressed onto the surface of sheet 50 and separated neatly from the surface of blanket 44. Subsequently, sheet 50 is transported to output stack 88.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets, thereby placement of the ink image, by forming station 60, on the surface of blanket 44.

In some embodiments, impression cylinder 82 is periodically engaged to and disengaged from blanket 44 to transfer the ink images from moving blanket 44 to the target substrate passing between blanket 44 and impression cylinder 82. In some embodiments, system 10 is configured to apply torque to blanket 44 using the aforementioned rollers and dancers, so as to maintain the upper run taut and to substantially isolate the upper run of blanket 44 from being affected by any mechanical vibrations occurred in the lower run.

In some embodiments, system 10 comprises an image quality control station 55, also referred to herein as an automatic quality management (AQM) system, which serves as a closed loop inspection system integrated in system 10. In some embodiments, station 55 may be positioned adjacent to impression cylinder 82, as shown in FIG. 1, or at any other suitable location in system 10.

In some embodiments, station 55 comprises a camera (not shown), which is configured to acquire one or more digital images of the aforementioned ink image printed on sheet 50. In some embodiments, the camera may comprises any suitable image sensor, such as a Contact Image Sensor (CIS) or a Complementary metal oxide semiconductor (CMOS) image sensor, and a scanner comprising a slit having a width of about one meter or any other suitable width.

In some embodiments, station 55 may comprise a spectrophotometer (not shown) configured to monitor the quality of the ink printed on sheet 50.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, color-to-color registration, printed geometry, image uniformity, profile and linearity of colors, and functionality of the print nozzles. In some embodiments, processor 20 is configured to automatically detect various distortions, such as geometrical distortions or other errors in one or more of the aforementioned attributes. For example, processor 20 is configured to compare between a design version of a given digital image and a digital image of the printed version of the given image, which is acquired by the camera.

In other embodiments, processor 20 may apply any suitable type image processing software, e.g., to a test pattern, for detecting distortions indicative of the aforementioned errors. In some embodiments, processor 20 is configured to analyze the detected distortion in order to apply a corrective action to the malfunctioning module, and/or to feed instructions to another module or station of system 10, so as to compensate for the detected distortion.

In some embodiments, by acquiring images of the testing marks printed at the bevels of sheet 50, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of threshold, and (iii) output sheets 50 having minor distortions, e.g., below the second set of thresholds, to output stack 88.

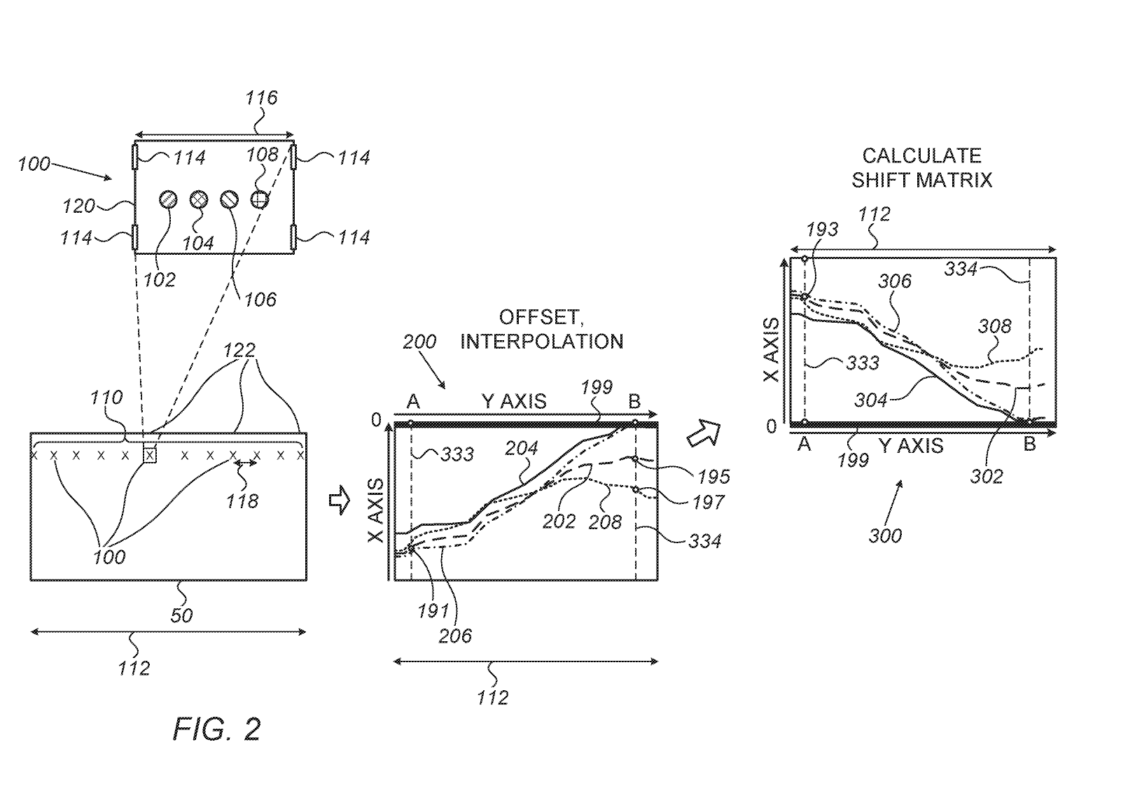

In some embodiments, processor 20 is further configured to detect, e.g., by analyzing a pattern of the printed inspection marks, additional distortions such as scaling up or down, skew, or a wave distortion formed in at least one of an axis parallel to and an axis orthogonal to the movement axis of blanket 44 as will be described in detail in FIGS. 2-6 below.

In some embodiments, processor 20 is configured to analyze the signals acquired by station 55 so as to monitor the nozzles of image forming station 60. By printing a test pattern of each color of station 60, processor 20 is configured to identify various types of defects indicative of malfunctions in the operation of the respective nozzles.

For example, absence of ink in a designated location in the test pattern is indicative of a missing or blocked nozzle. A shift of a printed pattern (relative to the original design) is indicative of inaccurate positioning of a respective print bar 62 or of one or more nozzles of the respective print bar. Non-uniform thickness of a printed feature of the test pattern is indicative of width differences between respective print bars 62, referred to above as bar to bar width delta.

In some embodiments, processor 20 is configured to detect, based on signals received from the spectrophotometer of station 55, deviations in the profile and linearity of the printed colors.

In some embodiments, processor 20 is configured to detect, based on the signals acquired by station 55, various types of defects: (i) in the substrate (e.g., blanket 44 and/or sheet 50 and/or any other substrate transferred in system 10), such as a scratch, a pin hole, and a broken edge, and (ii) printing-related defects, such as irregular color spots, satellites, and splashes.

In some embodiments, processor 20 is configured to detect these defects by comparing between a section of the printed and a respective reference section of the original design, also referred to herein as a master. Processor 20 is further configured to classify the defects, and, based on the classification and predefined criteria, to reject sheets 50 having defects that are not within the specified predefined criteria.

In some embodiments, the processor of station 55 is configured to decide whether to stop the operation of system 10, for example, in case the defect density is above a specified threshold. The processor of station 55 is further configured to initiate a corrective action in one or more of the modules and stations of system 10, as described above. The corrective action may be carried out on-the-fly (while system 10 continue the printing process), or offline, by stopping the printing operation and fixing the problem in a respective modules and/or station of system 10. In other embodiments, any other processor or controller of system 10 (e.g., processor 20 or controller 54) is configured to start a corrective action or to stop the operation of system 10 in case the defect density is above a specified threshold.

Additionally or alternatively, processor 20 is configured to receive, e.g., from station 55, signals indicative of additional types of defects and problems in the printing process of system 10. Based on these signals processor 20 is configured to automatically estimate the level of pattern placement accuracy and additional types of defects not mentioned above. In other embodiments, any other suitable method for examining the pattern printed on sheets 50 (or on any other substrate described above), can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configurations of system 10 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems.

### Distortions Caused by Errors in the Printing Process

Various errors in system 10 and/or in the printing process may cause various types of distortions in the printed image, such as non-linear profiles referred to herein as wave distortions. For example, (i) erroneous positioning of one or more print bars 62 in image forming station 60 (ii) deviation from the specified motion profile of blanket 44, and (iii) deviation from the specified relative velocity between blanket 44 and sheet 50 at impression station 84. As described above, print bars 62 are positioned at a predefined distance from one another along the movement axis of blanket 44, which is represented by arrow 94 and also referred to herein as X axis. Each print bar 62 is mounted on the frame on an axis orthogonal to arrow 94, referred to herein as Y axis.

The distortions described above, and additional errors, may result in a wavy pattern of the printed features. Note that typically the wavy pattern has two components: (i) a common wave of all colors, e.g., due to the aforementioned deviation at impression station 84, and (ii) different waves formed in each color image are caused, for example, by the erroneous positioning of one or more print bars 62 and/or due to temporary variations in the stretching pattern of the blanket. The common wave to all colors may result in a displacement of the digital image relative to the substrate, also referred to herein as “image to substrate” (Im2Sub). The Im2Sub may happened in X axis, referred to herein as Im2SubX, and/or in Y axis, referred to herein as Im2SubY.

Additional types of distortions may cause deviation of the printed width between bars, also referred to as bar to bar width delta, and/or shift (e.g., in Y axis) of the position of the droplets jetted by at least one bar, also referred to herein as “bar to bar Y position delta” or as “color to color (C2C) position difference Y.” Based on the above, the wave distortion has two components, distortion along X axis that changes with the position on Y axis, referred to herein as wave X(Y), and distortion along Y axis that changes with the position on X axis, referred to herein as wave Y(X). Further details about the distortion and correction of wave Y(X) are described, for example, in U.S. Provisional Patent Application 62/767,533, which is incorporated herein by reference.

### Calculating Correction of Distortion in a Digital Image Using a Calibration Table

FIG. 2 is a schematic, pictorial illustration of a method for calculating correction of a wave X(Y) distortion in an image printed by system 10, in accordance with an embodiment of the present invention. The image of FIG. 2 may replace, for example, image 42 of FIG. 1 above. The method begins with printing a layout 110 of multiple registration frames 100 in an image printed on sheet 50, or any other suitable target substrate. In the example of FIG. 2, layout 110 comprises twelve registration frames 100 laid out, at a distance 118 from one another, across a width 112 of sheet 50, which is moved by system 10.

Reference is now made to an inset 120. In the example of FIG. 2, each registration frame 100 comprises four registration targets 102, 104, 106 and 108 designed in four respective different colors, such as cyan (C), magenta (M), yellow (Y) and black (K). In some embodiments, registration targets 102, 104, 106 and 108 may be laid out, for example, across a width 116 of registration frame 100, or using any other suitable layout.

In some embodiments, registration frame 100 comprises scaling marks 114 laid out at the corners of registration frame 100, or at any other suitable location thereof. In some embodiments, processor 20 is configured to calculate the scaling of the image printed on sheet 50 using the distance measured between scaling marks 114, e.g., by dividing the nominal distance from the graphics by the corresponding measured pixel value.

The configuration of layout 110 and the arrangement of registration targets 102, 104, 106 and 108 within registration frame 100, are provided by way of example. In other embodiments, layout 110 may comprise any suitable number of registration frames 100, arranged on sheet 50 using any suitable configuration. Moreover, each registration frames 100 may have any suitable number of registration targets arranged within registration frames 100 using any suitable configuration and layout. For example, in an image having another scheme of colors, each registration frame 100 may comprise seven registration targets, each of which representing a different color. Note that registration frame 100 shown in inset 120 represents the original design of registration frames 100, marks 114 and registration targets 102, 104, 106 and 108 described above, i.e., without any distortion, such as the wave distortions described above.

As described in FIG. 1 above, the print heads of image forming station 60 are jetting ink droplets of the C, M, Y and K colors so as to form the ink image on the surface of blanket 44, and sheet 50 receives the ink image from blanket 44 at impression station 84.

In some embodiments, after printing the aforementioned registration frames and targets thereon, sheet 50 is placed on a calibration table (not shown), typically external to system 10 but may also be physically coupled to system 10. In some embodiments, the calibration table may be mounted on a movable XYZ stage comprising position encoders for recording at least the XY position of each of the aforementioned registration targets printed on sheet 50.

In some embodiments, a high resolution camera (not shown) is mounted adjacent to the calibration table, and is configured to acquire multiple digital images of sections of sheet 50. In the example of FIG. 2, the camera acquires twelve digital images of the corresponding twelve registration frames of layout 110, each digital image typically comprises one registration frame 100. The camera further acquires multiple (e.g., twelve or more) digital images of multiple points 122 located at the edge of sheet 50. Note that the camera may have multiple magnification capabilities, therefore a user of the camera and calibration table may select the number of registration frames 100 and/or points 122 acquired per each digital image, based on the desired resolution of registration frames 100 and/or points 122 in the acquired digital images. In other embodiments, the frame size and selected resolution of the camera may use the same image to show the targets along with the paper edge.

In some embodiments, processor 20 receives the digital images acquired by the camera, and from the XY encoders of the calibration table, processor 20 receives the corresponding XY coordinates (e.g., a lower left corner of the respective image, acquired in a coordinate system of the calibration table) of each image.

In some embodiments, processor 20 is configured to calculate, based on the received images and corresponding XY coordinates, the distance of each registration target from the edge of sheet 50, and therefore the Im2Sub of the printed image. Processor 20 is further configured to calculate the X(Y) distortion of the image printed by system 10 on sheet 50.

Reference is now made to a graph 200 showing wave X(Y) distortion of the registration targets of layout 110 described above. In some embodiments, graph 200 comprises the distortion of the C, M, Y and K colors along X axis (in the vertical axis of graph 200) that changes with the position on Y axis (in the horizontal axis of graph 200). The distortion of the C, M, Y and K colors along X axis is represented by lines 202, 204, 206 and 208 of graph 200, respectively.

In some embodiments, processor 20 is configured to calculate, for each registration target, the displacement between the designed and actual locations measured by the XY encoders of the stage moving the calibration table.

In some embodiments, processor 20 is configured to calculate the registration target farthest from the edge of sheet 50, and to interpolate the estimated wave X(Y) distortion between adjacent registration targets of each color, so as to form, for each color, a curve of the wave X(Y) distortion, as will be described below.

In some embodiments, processor 20 is further configured to apply moving average to a predefined number of adjacent data points of at least one of the curves of each color. Additionally or alternatively, processor 20 is configured to smooth the shape of the curves by applying any suitable convolution between a kernel and an image of the respective curves.

In some embodiments, processor 20 is configured to set a virtual reference curve, represented in graph 200 as a curve 199, which may be tangential to a point farthest from the edge of sheet 50 on the respective curve of the wave X(Y) distortion. In the example of graph 200, curve 199 is set at a marker “B” where lines 204 and 206 of the respective magenta and yellow curves are farthest from the edge of sheet 50. Processor 20 is further configured to set curve 199 at the target line, shown in image 2 as the origin of the X axis of graph 200.

In some embodiments, the distance between each point along lines 202, 204, 206 and 208 and a corresponding point along curve 199 is indicative of the distortion of each color image relative to the reference curve. For example, points 195 and 197 of respective lines 202 and 208 are crossing a dashed line 334, which is orthogonal to curve 199 at the position of marker “B” along Y axis of the image printed on sheet 50. Therefore, the distance, along line 334, between point 195 and marker “B” is indicative of the distortion of the cyan image relative to the reference curve, at the position of marker “B” on the Y axis of sheet 50.

Note that processor 20 is configured to calculate the distortion at each registration target as well as between the registration targets, which means calculating the distortion of each color at each respective section of the image printed by system 10.

In some embodiments, the distortion is indicative of the displacement (e.g., in micrometers) of each of the registration targets in X axis, relative to the design shown in layout 110 of the registration targets. As described above, processor 20 is configured to form lines 202, 204, 206 and 208 by estimating the distortion between the measured registration targets. For example, processor 20 may calculate a linear or polynomial interpolation between adjacent registration targets, or may use any other suitable method for calculating and displaying lines 202, 204, 206 and 208.

The interpolated lines are referred to herein as wave profile curves representing the shift distortion occurred during the printing for each respective color of system 10. The term “wave profile curve” is also referred to below simply as “wave curve” or “profile curve” for brevity.

In some embodiments, processor 20 is configured to identify the type of distortion based on graph 200. For example, markers “A” and “B” of graph 200 are located at two positions along the Y axis, and shown as respective dashed lines 333 and 334, extended along X axis of graph 200. At the position of marker “A,” all colors have a relatively large Im2SubX distortion and a relatively low C2C distortion, as shown by the distance of lines 202, 204, 206 and 208 from curve 199 and from one another. As described above, at the position of marker “B,” the magenta and yellow curves of respective lines 204 and 206, are not displaced relative to curve 199. However, the cyan and mainly the black curves of respective lines 202 and 208 are indicative of a C2C distortion shown by the distance, measured along dashed line 334, of points 195 and 197 from marker “B.”

### Compensating for Distortions

Reference is now made to a graph 300. After forming the distortion curve of each color of the image printed by system 10, processor 20 is configured to calculate profiles for correcting the wave X(Y) distorted profiles of graph 200. In some embodiments, processor 20 is configured to shift one or more pixels of the image so as to compensate for the X(Y) distortion shown in graph 200. Graph 300 will be depicted in detail after the following description of the formation of the digital image and printed image in system 10.

In some embodiments, processor 20 produces a digital image to be printed on blanket 44 (and later transferred to sheet 50) in multiple steps that comprise, among other steps, rasterization and screening steps. In the rasterization step processor 20 receives, for each section of the digital image, an image described in a vector graphics format (i.e., shape properties) and converts the vector graphics format into a raster image having pixels or dots. Each pixel has a color in a given color space, such as red-green-blue (RGB), or cyan-magenta-yellow-black (CMYK), or any other color space, and a continuous tone value i.e., gray level (0-255 in case of 8 bit representation).

In the context of the present disclosure and in the claims, the term “gray level” in a color image, refers to a scale indicative of the brightness level of the colors in the predefined color space of the digital images. For example, in a green channel of an image having a RGB color space, which comprises two areas having respective gray levels of 100 and 200, the area with gray level 200 will have a green color brighter than the area with gray level 100.

In some embodiments, processor 20 is configured to convert the digital image from continuous tone imagery to “half tone” through the use of dots, varying in size and/or in spacing, thus generating the desired gray level (and/or a gradient-like effect across the image). In the context of the present invention and in the claims, the term “half tone” refers to whether or not system 10 will jet a droplet of ink at a given location on the surface of sheet 50, and what will be the size of the droplet at the given location.

In some embodiments, processor 20 may send a 2-bit instruction to a specific nozzle of image forming station 60 to jet, at the given location of sheet 50, one of the following options: (a) no jetting, (b) jetting a droplet having a regular size, typically defined in the printing specification, (c) a large droplet, typically comprising two regular-size droplets jetted on sheet 50 at the given location, and (d) a larger droplet, which may comprise three regular-size droplets jetted at the given location. As described above, the density of droplets and the actual size of each droplet will set the gray level of the respective color in a selected section of the image as perceived by an observer's eye.

In some embodiments, at the screening step, in addition to converting from continuous tone to half toning, processor 20 converts the raster image between color spaces into a combination of the colors of system 10 (e.g., the aforementioned C, M, Y and K colors, or any other set of colors) for each section and pixel, also referred to herein as “region of pixels,” of the digital image.

In some embodiments, processor 20 is configured to carry out the toning conversion and the color-space conversion using any suitable sequence, e.g., simultaneously, or performing the toning conversion after the color-space conversion, or vice versa (i.e., performing the color-space conversion after the toning conversion).

In some embodiments, processor 20 is configured to control the eye perceived gray levels of each section of the printed image, by controlling at each region of pixels, the density and size of droplets of each color of ink applied to the surface of blanket 44 and transferred to the target substrate (e.g. sheet 50).

In some embodiments, processor 20 is configured to compensate for the wave X(Y) distortion shown in graph 200, by shifting one or more pixels at one or more sections of the digital image acquired by the aforementioned camera.

Note that processor 20 calculates the pixel shifting separately for each color image formed at a step following the screening step described above.

In some embodiments, processor 20 is configured to calculate the compensating shift of the curves described in graph 200 above relative to any suitable reference, such as the reference curve described above.

In some embodiments, graph 300 comprises lines 302, 304, 306 and 308 representing the shifting distance of one or more pixels at respective sections of the C, M, Y and K color images. The horizontal axis of graph 300 represents the location on Y axis, and the vertical axis of graph 300 represents the shifting distance (e.g., in micrometers), in X axis, of the one or more pixels at each section along the Y axis of the image.

Note that curves 199, which are laid out at the origin of the X axis of the reference curves of graphs 200 and 300, are aligned with one another along the X axis. In the example of FIG. 2, the X value of all the points of graph 200 are equal to zero or negative. On the other hand, the X value of all the points of graph 300 are equal to zero or positive.

In some embodiments, based on the wave X(Y) distortion calculated and displayed in graph 200, processor 20 is configured to calculate the compensating shift of the curves shown in graph 300. For example, as shown in graph 200, at the position of marker “A,” processor 20 calculated that the yellow pixels of line 206 were shifted, relative to the reference curve, by about −1500 μm due to the wave X(Y) distortion.

In other words, the distance along dashed line 333 of graph 200, between marker “A” and point 191 is similar to the distance, between marker “A” and point 193, along dashed line 333 of graph 300. Therefore, as shown in line 306 of graph 300, processor 20 may shift the yellow pixels at the position of marker “A” by a number of pixels equals to a distance of 1500 μm in a direction opposite to the shift caused by the wave X(Y). For example, using a pixel size of 42 μm, processor 20 may shift the pixels at the position of marker “A” of the yellow color image by 36 pixels.

In some embodiments, processor 20 is configured to shift multiple pixels having any shape and configuration, for example, the shifted pixels may be arranged as a bar of pixels along a section of the digital image. In some embodiments, the section may comprise a column or row of at least one of the color images.

In some embodiments, at the last step of the method as shown in graph 300, processor 20 is configured to output a calculated shift matrix for each section of each color of the printed image. The calculated shift matrix may be in the form one or more instructions that, when applied to specific stations of system 10, compensate for the wave X(Y) distortion of each color separately, and produce corrected color images whose wave X(Y) distortions are minimized or eliminated.

In some embodiments, processor 20 is configured to send a separate instruction to each nozzle of image forming station 60. For example, in accordance with the 2 bit instruction described above, at a given location on the surface of sheet 50, a first nozzle may receive an instruction to jet two droplet in order to form a large droplet of the respective color, and a second nozzle may receive an instruction not to jet any droplet at the given location.

### Calculating Correction of Distortion in a Digital Image Using the Image Quality Control Station

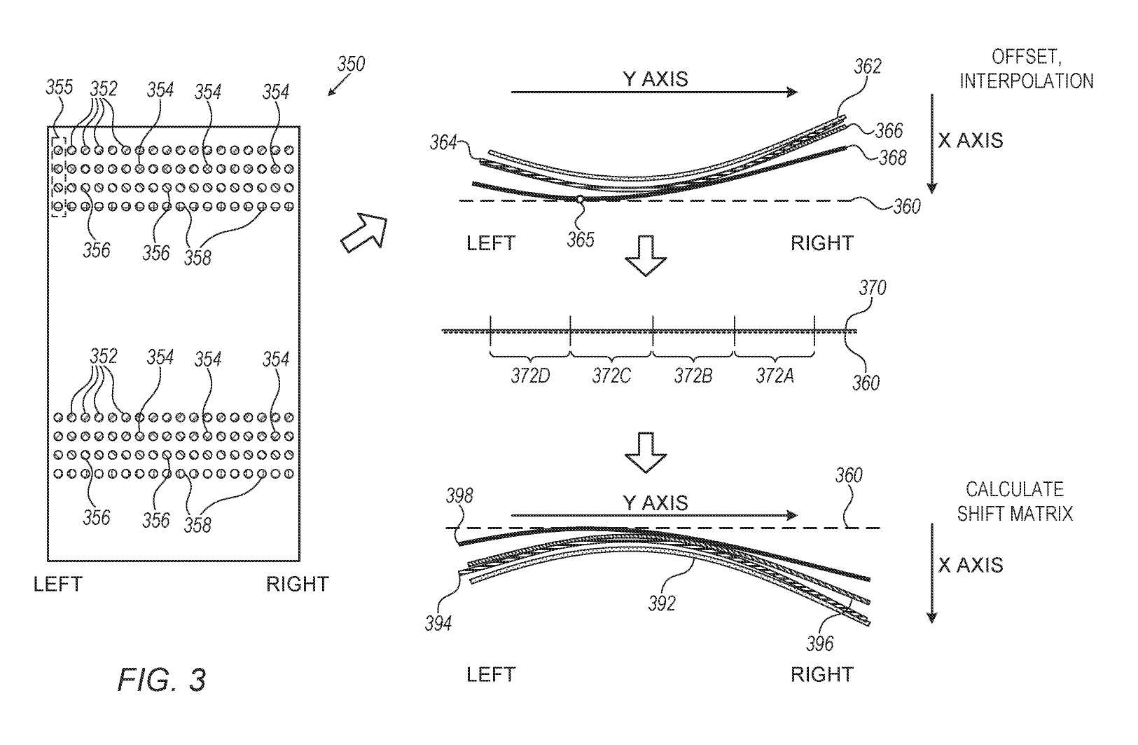

FIG. 3 is a schematic, pictorial illustration of a method for calculating correction of a wave X(Y) distortion in an image 350 printed by system 10, in accordance with an embodiment of the present invention. Image 350 may replace, for example, image 42 of FIG. 1 above. In some embodiments, image 350 comprises multiple lines of registration targets arranged in lines or in any suitable other configuration.

In some embodiments, image 350 comprises one or more array of four lines, corresponding to the C, M, Y and K colors. Each line comprises any suitable number (e.g., a few hundreds) of registration targets of one color arranged at a predefined distance from one another. Each registration target comprises a plurality pixels.

In the example of FIG. 3, image 350 comprises two similar arrays, each array comprises a first line comprising cyan registration targets 352, a second line comprising magenta registration targets 354, a third line comprising yellow registration targets 356, and a fourth line comprising black registration targets 358. The lines are laid out at an equal distance from one another and the registration targets of each color are arranged in columns, for example, a column 355 located farthest to the left of the array.

In other embodiments, image 350 may comprise any other suitable number of registration targets arranged in any suitable configuration.

In some embodiments, system 10 prints image 350 on sheet 50 and subsequently, station 55 acquires and sends a digital format of image 350 to processor 20 or to any other processor.

In some embodiments, processor 20 inserts a constant offset to each line registration targets so as to align registration targets 352, 354, 356 and 358 to a common position. Processor 20 is further configured to form a set of interpolated curves between the respective registration targets of each color.

In some embodiments, in the design of the registration targets there is a deliberate shift between the lines of registration targets so that they will not be printed on top of one another. In some embodiment, processor 20 is configured to align the location of all the registration targets of each column (e.g., in column 355) to the common position per the predetermined graphics offset, and subsequently, to determine which registration targets are shifted (e.g., relative to the common position).

The interpolated curves are referred to herein as wave profile curves representing the shift distortion occurred during the printing for each respective color of system 10. The term “wave profile curve” is also referred to below simply as “curve” for brevity.

In the example of FIG. 3 processor 20 produces four curves corresponding to the four lines of registration targets 352, 354, 356 and 358: a cyan curve 362, a magenta curve 364, a yellow curve 366 and a black curve 368.

In some embodiments, processor 20 is configured to apply moving average to a predefined number of adjacent data points of at least one of curves 362, 364, 366 and 368, so as to smooth the shape of these curves. Additionally or alternatively, processor 20 is configured to smooth the shape of curves 362, 364, 366 and 368 by applying any suitable type of convolution matrix between a kernel and an image of each curves 362, 364, 366 and 368.

In some case, e.g., due to the physical size of the registration targets and gaps in between—not all available pixels range will be active during the printing, hence left and/or right edges of sheet 50 may not be printed. In some embodiments, processor 20 is configured to extrapolate at least some of curves 362, 364, 366 and 368 so as to incorporate the unprinted regions of pixels. The extrapolated section of the curve may have a slope so as to be aligned with the slope of the respective curve, or may have any other shape, such as a horizontal line parallel to the Y axis of sheet 50.

In some embodiments, processor 20 is configured to calculate, based on the digital image received from image quality control station 55, which registration target or curve of image 350 has the largest shift due to the wave X(Y) distortion. This point is also referred to herein as a “farthest point” from the common position described above.

In some embodiments, the calculation of the farthest point may be carried out before the interpolation and formation of the registration curves, so as to reduce the data load in the calculation, or after the formation of the registration curves, so as to increase the position accuracy of the farthest point.

In some embodiments, processor 20 is configured to calculate the compensating shift of the curves relative to a shift edge pixel, also referred to herein as a reference curve 360, which may be tangential to the farthest point.

In the example of FIG. 3, black curve 368 has the largest shift due to the wave X(Y) distortion and the farthest point is a point 365, which is the tangential point between curves 360 and 368.

In some embodiments, processor 20 is configured to calculate, for each color image, a shift matrix that compensates for the shift distortion caused during the printing to each respective curve.

In some embodiments, processor 20 may apply a linear or non-linear shifting so as to compensate for part of the wave X(Y) distortion caused, for example, by bending and stretching of the flexible ITM and from applied yaw generated by impression station 84. Processor 20 is further configured to compensate for the Im2SubX in any of the color images using linear offset or any other suitable technique. Note that the aforementioned shifting and offset, may differ along different sections of the color images and are configured to align between edges of the color images so as to obtain alignment between all color images.

In some embodiments, processor 20 is further configured to divide curve 360 to multiple sections that serve as correction strips 372A-372D such that the shift matrix comprises the calculated shift for each of the correction strip. In an embodiment, processor 20 is configured to set and use any suitable number of correction strips, each strip 372 may have any suitable size, which may be similar to or different from the size of the other strips.

In the example of FIG. 3, the calculated shift matrix has four curves 392, 394, 396 and 398 corresponding to curves 362, 364, 366 and 368. Note that curves 392, 394, 396 and 398 of the calculated shift matrix are shaped like a mirror image of the distorted curves, i.e., curves 362, 364, 366 and 368.

As shown in FIG. 2 above, after applying the shift matrix the curves of the cyan and magenta images are aligned with one another. In the example of FIG. 3, processor 20 is configured to calculate a line 370, which represents all the ends of the cyan, magenta, yellow and black images, aligned with one another and with reference curve 360.

In some embodiments, the calculation of the farthest point may be carried out before interpolating between adjacent registration targets and formation of the curves by processor 20. In the example of FIG. 2 above, there are only twelve registration targets of each color laid out across width 112 of sheet 50, therefore, the position accuracy of marker “B,” which is the farthest point at FIG. 2, may not be sufficient for setting curve 199 at a sufficient accuracy. Therefore, in the example of FIG. 2, processor 20 may first produce lines 202, 204, 206 and 208 of graph 200, and subsequently calculate the farthest point.

In the example of FIG. 3, however, the automatic inspection by image quality control station 55 allows using a large number of registration targets laid out at high density along the Y axis of the respective registration line. Therefore, processor 20 may have sufficient data to determine the farthest point (e.g., point 365) and curve 360.

Based on the above, processor 20 may use the same calculation for setting the farthest point at FIGS. 2 and 3, or may calculate marker “B” and point 365 using different methods.

This particular configuration and layouts of the registration targets in FIGS. 2 and 3 are shown by way of example, in order to illustrate certain problems, such as wave X(Y) distortion, which are addressed by embodiments of the present invention and to demonstrate the application of these embodiments in enhancing the performance of system 10. Embodiments of the present invention, however, are by no means limited to this specific sort of example configuration of registration targets and system, and the principles described herein may similarly be applied to any other sorts of printing systems.

In other embodiments, the registration targets may be laid out at margins surrounding a product image, or at any other position on sheet 50 so as to enable correction of the wave X(Y distortion, and other distortion caused during the printing on sheet 50, during printing of product images in high volume mode of printing.

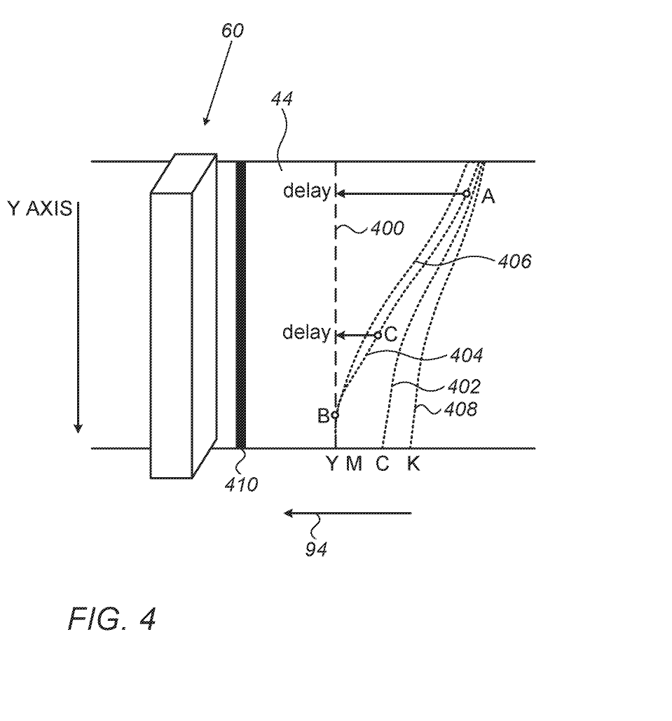

FIG. 4 is a schematic, pictorial illustration of a method for implementing the calculated profiles of FIGS. 2 and 3 in digital printing system 10, in accordance with an embodiment of the present invention.

In some embodiments, dashed lines 402, 404, 406 and 408 on the surface of blanket 44 are virtual lines indicative of the wave X(Y) distortion shown, respectively, by lines 202, 204, 206 and 208 of FIG. 2 above, and by curves 362, 364, 366 and 368 of FIG. 3 above. Therefore, dashed lines 402, 404, 406 and 408 correspond to the distorted C, M, Y and K color images. Note that the actual shape of the wave X(Y) distortion formed in blanket 44 during the operation of system 10, is not identical to shape of lines 402, 404, 406 and 408, because at least part of the wave X(Y) distortion may be caused, as described above, by other elements of system 10 such as impression station 84.

In some embodiments, a dashed line 400 on the surface of blanket 44, is indicative of a virtual reference curve used for correcting the wave X(Y) distortion represented by lines 402, 404, 406 and 408. In some embodiments, virtual markers “A,” “B” and “C” are indicative of pixels located at three sections of line 404, along the Y axis of blanket 44.

In some embodiments, processor 20 is configured to compensate for the wave X(Y) distortion in the magenta color image by shifting the pixels located along line 404, such that virtual markers “A,” “B” and “C” are jetted in delay at the position of dashed line 400.

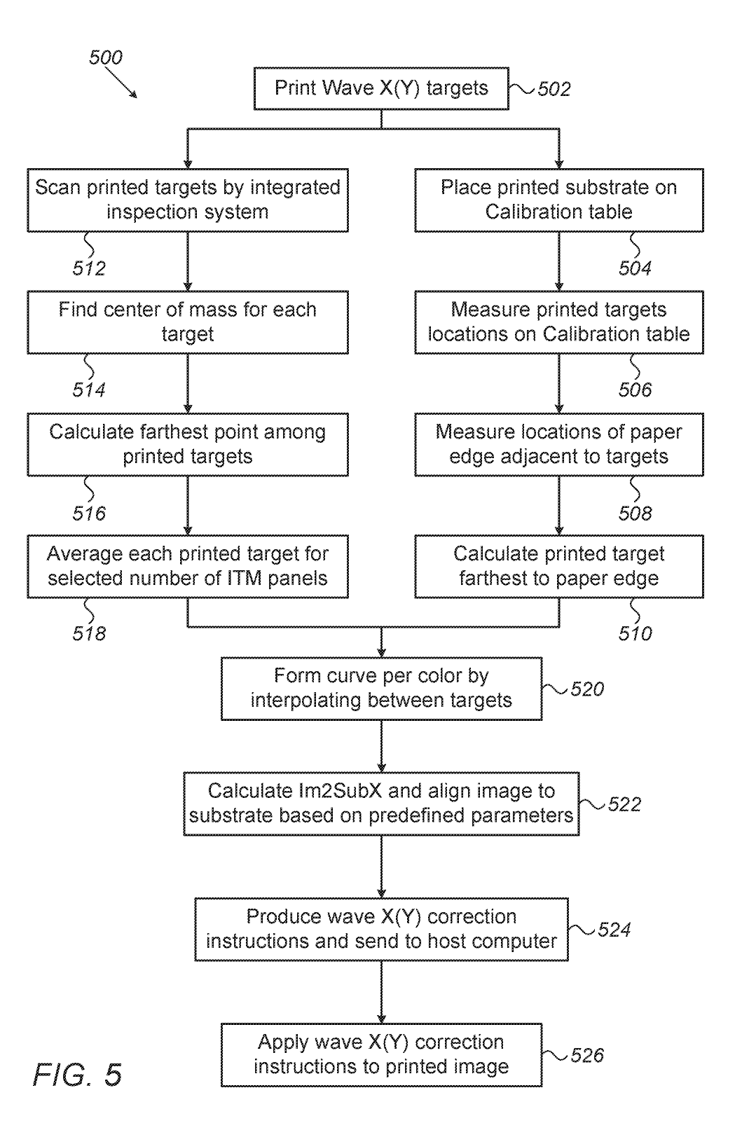

In some embodiments, processor 20 may cause the pixel shifting by controlling the jetting time of the magenta ink applied to blanket 44 by image forming station 60. In the example method of FIG. 5 that will be described below, processor 20 may delay the jetting of at least some of the magenta ink droplets on the surface of blanket 44, so as to compensate for the wave X(Y) distortion in the magenta color image.

In other embodiments, processor 20 may precede the jetting of at least some ink droplets on the surface of blanket 44, so as to compensate for the wave X(Y) distortion in any of the color images.

In alternative embodiments, processor 20 may precede the jetting of ink droplets from some nozzles of image forming station 60, and during the same printing process, processor 20 may delay the jetting of ink droplets from other nozzles of image forming station 60. By changing the jetting time of the ink droplets, processor 20 may cause shifting of pixels at selected sections and colors of the ink image, thereby compensating for the wave X(Y) distortion in the ink image.

In some embodiments, processor 20 may change the jetting time during or after the screening step described in FIG. 4 above. In other words, after converting the raster image into a combination of color images corresponding to the colors of system 10 (e.g., C, M, Y and K colors), processor 20 may apply the change of jetting time to selected sections of selected color images, so as to correct the wave X(Y) distortion in the image to be printed by system 10.

In some embodiments, processor 20 applies the calculated shift matrix (e.g., one of the shift matrices described in FIGS. 2 and 3 above) to image forming station 60 and blanket 44, so as to correct the wave X(Y) distortion by adjusting the jetting time of ink from image forming station 60 relative to the position of blanket 44. In the example of FIG. 4, the distortion correction is illustrated by a line 410 applied to the surface of blanket 44 by image forming station 60. It will be understood that the actual shape of line 410 on blanket 44 is typically not straight as appears in line 410, because the shift matrix also compensates for other wave X(Y) distortions caused, for example, by impression station 84, as described in FIGS. 1 and 2 above.

FIG. 5 is a flow chart that schematically illustrates a method 500 for correcting distortions in an image printed using digital printing system 10, in accordance with an embodiment of the present invention. In some embodiments, method 500 comprises two optional branches corresponding to different selectable modes of operation: (a) an off-system 10 mode depicted in FIG. 2 above and described at steps 504, 506, 508 and 510, and (b) an integrated-inspection mode depicted in FIG. 3 above and described at steps 512, 514, 516 and 518. The two branches merge at a curve formation step 520.

In some embodiments, the method begins with system 10 printing the wave X(Y) registration targets at a targets printing step 502. The registration targets are referred to in FIG. 5 as “targets” for brevity. In some embodiments, at step 502, system 10 prints the registration targets on a target substrate, such as sheet 50. Note that step 502 is applicable for both aforementioned modes of operation. In the off-system 10 mode, the registration targets may comprise targets 102, 104, 106 and 108 arranged, for example, in layout 110, as depicted in FIG. 2 above. In the integrated-inspection mode, the registration targets may comprise targets 352, 354, 356 and 358 arranged, e.g., in image 350, as depicted in FIG. 3 above.

Reference is now made to the off-system 10 mode branch that begins with placing sheet 50 on the calibration table, as described with reference to FIG. 2 above, at a substrate placement step 504. As described at step 502, targets 102, 104, 106 and 108 are printed on sheet 502. At a target location measurement step 506, processor 20 applies the camera and encoders depicted in FIG. 2 above, to measure the position of printed targets 102, 104, 106 and 108 of all registration frames 100.

At a paper edge measurement step 508, processor 20 measures the locations at the edge of sheet 50 that are in close proximity to the respective registration targets of frames 100. At a distance calculation step 510, processor 20 calculates, based on the acquired images and XY positions received from the encoders, the distance between each registration target and respective closest edge of sheet 50. In some embodiments, the paper edge may be measured at two points so as to allow a linear calculation of the aforementioned distances. In other embodiments, the paper edge may be measured at multiple points relative to each registration target so as to minimize mechanical inaccuracies of the calibration table itself. In yet other embodiments, processor 20 may use any other suitable sampling for the calculation described above.

In some embodiments, based on the calculated distance(s) of step 510, processor 20 identifies one or more registration targets located at the farthest distance (from among all registration targets) to the edge of sheet 50. For example, as described in FIG. 2, processor 20 identifies marker “B” as the target located at the farthest distance from the edge of sheet 50.

As will be described below, processor 20 uses the distance of the farthest location to compensate for the Im2SubX and wave X(Y) distortions. Step 510 concludes the off-system 10 branch.

Reference is now made to the integrated inspection branch. At a target scanning step 512, processor 20 applies image quality control station 55 to scan registration targets 352, 354, 356 and 358 printed on sheet 50. As described in FIG. 3 above, each of the registration targets comprises a plurality of pixels. At a center of mass (COM) detection step 514, processor 20 calculates the COM of the pixels in each registration target of image 350.

At a farthest point calculation step 516, processor 20 calculates, based on the targets scanned by station 55, the farthest point among the targets printed on sheet 50 relative to the paper edge. In the example of FIG. 3, processor 20 calculates point 365 of the black image as the farthest point in image 350.

In some embodiments, blanket 44 may comprise multiple (e.g., eleven) sections, also referred to herein as “ITM panels.” Each ITM panel receives ink droplets from station 60 so as to form image 350 thereon. In other words, blanket 44 may have eleven sets of image 350 at eleven respective sections of blanket 44. In other embodiments, processor 20 may set any other number of ITM panels along a cycle of blanket 44. The number of ITM panels in blanket 44 may depend on the size of image 350 and/or on any other parameter of system 10.

In some embodiments, processor 20 may apply station 55 to scan eleven sheets 50 (related to the eleven ITM panels described above) so as to monitor distortions along the full cycle of blanket 44. Note that the automatic inspection of image 350 provides processor 20 with high volume of data (such as the COM and farthest point described at steps 514 and 516 above) that typically increases the precision calculated wave X(Y) distortion carried out by processor 20.

At an averaging step 518 that concludes the integrated inspection branch, processor 20 averages each calculated printed target for a selected number of ITM panels. For example, processor 20 may average the position and COM of eleven sets of target 352 of column 355, acquired from eleven respective ITM panels of blanket 44.

In some embodiments, processor 20 may also identify from among the eleven sets of target 352 of column 355, the target located at the largest distance from the average position calculated at step 518. Instead of or in addition to averaging, processor 20 may use the eleven sets of each registration target to calculate the median location of each registration target, so as to reduce the impact of an extreme value (e.g., due to a data integrity error) of one registration target, on the common location that will be used, at later steps of method 500, for correcting the wave X(Y) and Im2subX distortions.

Reference is now made to a curve formation step 520, which is applicable for both modes of operation described above. At curve formation step 520 processor 20 forms a curve for each row of registration targets, by interpolating between the registration targets of the respective row. Note that each curve represents the measured wave X(Y) distortion and the calculated wave X(Y) distortion of the respective color image and corresponds to lines 202, 204, 206 and 208 of FIG. 2 above, and to curves 362, 364, 366 and 368 of FIG. 3 above.

In some embodiments, processor 20 is further configured to calculate a moving average over a predefined number of adjacent data points of at least one of the curves of each color, so as to smooth the shape of the curves. Additionally or alternatively, processor 20 is configured to smooth the shape of the curves by applying any suitable type of a convolution matrix between a kernel and an image of each of the respective curves.

At an alignment step 522, processor 20 calculates, based on the positions of the registration targets acquired from the digital image, the Im2SubX of the printed image (e.g., image 350 relative to sheet 50), and based on predefined parameters, processor 20 aligns between image 350 and sheet 50. At a wave X(Y) correction step 524, processor 20 produces correction instructions that hold compensation information for the wave X(Y) distortion measured at step 520. Subsequently, processor 20 sends the correction instructions to a host computer of system 10 (e.g., console 12) and/or to a host computer managing the operations of the printing factory.

Note that the calculated wave X(Y) distortion may comprise the calculated Im2SubX distortion. In some embodiments, processor 20 is further configured to carry out steps 522 and 524 at the same time and/or at a reverse order, i.e., performing step 524 before 522. In other words, processor 20 typically calculates the wave X(Y) correction together with the Im2SubX correction, and produces one or more instructions comprising the correction of both distortions. In alternative embodiments, processor 20 may first calculate the wave X(Y) distortion, and subsequently calculates the Im2SubX correction so as to align between the image and sheet 50. The alignment is typically based on predefined parameters provided by the client of the printed image, such as margins between the edges of the printed image and the corresponding edges of sheet 50.

At a printing step 526 that concludes method 500, processor 20 applies the aforementioned correction instructions for correcting the wave X(Y) and Im2SubX distortion, to system 10, which prints the corrected image.

In some embodiments, processor 20 may repeat method 500 for any selected batch-size of digital printing. For example, processor 20 may apply method 500 to every printed sheet 50, based on the wave X(Y) distortion measured on one or more predecessor sheets 50 already processed. In some embodiments, the wave X(Y) distortion may be measured on registration targets embedded in sheet 50.

In some embodiments, the registration targets may be embedded outside the frame of the product image, e.g., at the margins between the edges of the product image and sheet 50.

Additionally or alternatively, the registration targets may be integrated into the design of the product image, for example, as small targets that are essentially invisible to a naked eye.

In alternative embodiments, system is configured to print a test image, such as image 350 shown in FIG. 3 above, on one or more ITM panels of blanket 44. For example, blanket 44 may comprise ten product images in ten respective ITM panels, and one test image on the eleventh ITM panel of blanket 44. In these embodiments, processor 20 is configured to apply method 500 for correcting wave X(Y) distortion (and optionally other types of distortions) in system 10, for every cycle of blanket 44, based on the distortion measured on the one or more predecessor blankets.

Note that the automated inspection carried out by image quality control station 55, allows processor 20 to calculate the aforementioned distortions based on one sample, or statistically based on multiple predecessor samples. For example, using a calculation such as a moving average and/or a moving median over four cycles of blanket 44 provides processor 20 with a wave X(Y) distortion calculated based on about forty-four sheets 50, each of which comprising a set of registration targets described, for example, in FIGS. 2 and 3 above.

Although the embodiments described herein mainly address sheet-fed digital printing, the methods and systems described herein can also be used in other applications, such as in digital printing on a continuous web substrate or any other substrates, or any other type of printing methods and systems, such as double sided sheet fed or web printing.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for correcting distortion in image printing, the method comprising:
receiving a digital image comprising at least first and second colors;
producing, based on the digital image, a first color image of the first color and a second color image of the second color;
estimating a first distortion in the first color image and a second distortion in the second color image;
calculating for the first color image one or more first pixel-shifts that, when applied to respective first pixels in the first color image, compensate for the estimated first distortion;
calculating for the second color image one or more second pixel-shifts that, when applied to respective second pixels in the second color image, compensate for the estimated second distortion;
producing a first corrected image by applying the first pixel-shifts to the respective first pixels, and producing a second corrected image by applying the second pixel-shifts to the respective second pixels; and
printing, on a target substrate, the first corrected image and the second corrected image.

2. The method according to claim 1, wherein printing the first corrected image comprises changing a first jetting time of a first printing fluid for correcting the first distortion, and wherein printing the second corrected image comprises changing a second jetting time of a second printing fluid for correcting the second distortion.

3. The method according to claim 1, wherein at least some of the first pixels comprise a bar of pixels along a section of a column or a row of the first color image, and wherein producing the first corrected image comprises applying at least one of the first pixel-shifts to the bar of pixels.

4. The method according to claim 1, wherein the first color image comprises one or more first registration targets laid out at respective one or more first designed positions, and wherein the second color image comprises one or more second registration targets laid out at respective one or more second designed positions.

5. The method according to claim 4, wherein estimating the first distortion comprises measuring a first displacement of at least one of the first registration targets from the first designed position to a first measured position, and wherein estimating the second distortion comprises measuring a second displacement of at least one of the second registration targets from the second designed position to a second measured position.

6. The method according to claim 5, wherein estimating the first distortion comprises calculating the first pixel-shifts based on the first displacement, and wherein estimating the second distortion comprises calculating the second pixel-shifts based on the second displacement.

7. The method according to claim 5, wherein producing the first corrected image comprises shifting the one or more first pixels so as to compensate for the first displacement, and wherein producing the second corrected image comprises shifting the one or more second pixels so as to compensate for the second displacement.

8. The method according to claim 4, wherein estimating the first distortion comprises producing a first distortion curve by interpolating between the first registration targets, and wherein estimating the second distortion comprises producing a second distortion curve by interpolating between the second registration targets.

9. The method according to claim 8, and comprising calculating a moving average over a predefined number of adjacent data points of at least one of the first and second distortion curves.

10. The method according to claim 4, wherein estimating the first and second distortions comprises measuring a first distance between at least one of the first registration targets and a first edge of the target substrate, and measuring a second distance between at least one of the second registration targets and a second edge of the target substrate.

11. The method according to claim 1, and comprising receiving multiple digital images acquired from multiple respective printed images and calculating multiple respective first and second color images, estimating multiple first and second distortions in each of the multiple first and second color images, and calculating first and second pixel-shifts based on a statistical analysis of the first and second distortions.

12. The method according to claim 1, and comprising aligning at least one of the first corrected image and the second corrected image to the substrate based on one or more predefined parameters.

13. The method according to claim 1, wherein the digital image is acquired from a printed image.

14. A printing system, comprising:
an intermediate transfer member (ITM) configured to receive droplets of at least first and second printing fluids from an image forming station so as to form thereon an ink image comprising at least a first color of the first printing fluid and a second color of the second printing fluid, and to form a printed image by transferring the ink image to a target substrate; and
a processor, which is configured to:
receive a digital image;
produce, based on the digital image, a first color image of the first color and a second color image of the second color;
estimate a first distortion in the first color image and a second distortion in the second color image;
calculate, for the first color image, one or more first pixel-shifts that, when applied to respective first pixels in the first color image, compensate for the estimated first distortion;
calculate, for the second color image, one or more second pixel-shifts that, when applied to respective second pixels in the second color image, compensate for the estimated second distortion;
produce a first corrected image by applying the first pixel-shifts to the respective first pixels, and produce a second corrected image by applying the second pixel-shifts to the respective second pixels; and
apply the first and second corrected images to the ITM by sending instructions comprising the first and second corrected images to the image forming station.

15. The system according to claim 14, wherein the processor is configured to change a first jetting time of the first printing fluid for correcting the first distortion, and to change a second jetting time of the second printing fluid for correcting the second distortion.

16. The system according to claim 14, wherein at least some of the first pixels comprises a bar of pixels along a section of a column or a row of the first color image, and wherein the processor is configured to apply at least one of the first pixel-shifts to the bar of pixels.

17. The system according to claim 14, wherein the first color image comprises one or more first registration targets laid out at respective one or more first designed positions, and wherein the second color image comprises one or more second registration targets laid out at respective one or more second designed positions.

18. The system according to claim 17, wherein the processor is configured to estimate the first distortion by measuring a first displacement of at least one of the first registration targets from the first designed position to a first measured position, and to estimate the second distortion by measuring a second displacement of at least one of the second registration targets from the second designed position to a second measured position.

19. The system according to claim 18, wherein the processor is configured to estimate the first distortion by calculating the first pixel-shifts based on the first displacement, and to estimate the second distortion by calculating the second pixel-shifts based on the second displacement.

20. The system according to claim 18, wherein the processor is configured to produce the first corrected image by shifting the one or more first pixels so as to compensate for the first displacement, and to produce the second corrected image by shifting the one or more second pixels so as to compensate for the second displacement.

21. The system according to claim 17, wherein the processor is configured to produce a first distortion curve by interpolating between the first registration targets, and to produce a second distortion curve by interpolating between the second registration targets.

22. The system according to claim 21, wherein the processor is configured to calculate a moving average over a predefined number of adjacent data points of at least one of the first and second distortion curves.

23. The system according to claim 17, wherein the processor is configured to estimate the first and second distortions by measuring a first distance between at least one of the first registration targets and a first edge of the target substrate, and by measuring a second distance between at least one of the second registration targets and a second edge of the target substrate.

24. The system according to claim 14, wherein the processor is configured to receive multiple digital images acquired from multiple respective printed images, to calculate multiple respective first and second color images, to estimate multiple first and second distortions in each of the first and second color images, and to calculate the first and second pixel-shifts based on a statistical analysis of the multiple first and second distortions.

25. The system according to claim 14, wherein the processor is configured to align at least one of the first corrected image and the second corrected image to the substrate, based on one or more predefined parameters.

26. The system according to claim 14, wherein the digital image is acquired from the printed image.
